(19) United States
(12) Patent Application Publication
(10) Pub. No.: US 2026/0368266 A1
(43) Pub. Date: Nov. 19, 2026

(54) TIMELINE OF DOCUMENT ACTIVITY

(71) Applicant: Zagmo Corporation, San Francisco, CA (US)

(72) Inventor: Scott Banister, San Rafael, CA (US)

(21) Appl. No.: 19/208,327

(22) Filed: May 14, 2025

(51) Int. Cl. G06F 16/9532; G06F 16/9032

(52) U.S. Cl. CPC G06F 16/9532; G06F 16/90332

(57) ABSTRACT

A change data associated with a set of one or more documents is received. At least a portion of the change data is used to generate a set of search results that is derived at least in part from a set of specified data. The set of search results is used to augment the change data as displayed via a user interface.

A query is received. At least a portion of the query is used to generate one or more LLM results that are derived at least in part from a set of specified data. The one or more LLM results is used to generate a set of search results to be displayed via a user interface.

A change data associated with a set of one or more documents is received. At least a portion of the change data is used to generate one or more search-tuned LLM results. At least a portion of the search-tuned LLM results is used to generate a set of search results that is derived at least in part from a set of specified data. The set of search results is used to augment the change data as displayed via a user interface.

### BACKGROUND OF THE INVENTION

Home and business work may involve collaboration on documents involving one or more users. As referred to herein, a document is a computer file and/or any discrete chunk of information, for example a word processor document, a spreadsheet, a slide presentation, an artifact, a group chat, a form, and/or a form response. In a work environment, one or more users may create, change, and/or delete one or more documents. Improving this collaboration on documents can improve workplace productivity.

### BRIEF DESCRIPTION OF THE DRAWINGS

Various embodiments of the invention are disclosed in the following detailed description and the accompanying drawings.

FIG. 1 is a functional diagram illustrating a programmed computer/server system for facilitating a timeline of document activity in accordance with some embodiments.

FIG. 2A is a user interface rendering illustrating an initial example of a timeline of document activity.

FIG. 2B is a user interface rendering illustrating a document example of a timeline of document activity.

FIG. 2C is a flow diagram illustrating an embodiment of a process for providing a timeline of document changes.

FIG. 3A is a screenshot illustration of an example of a document change.

FIG. 3B is a user interface rendering illustrating an example of a slide document change to a timeline of document activity.

FIG. 4A is a user interface rendering illustrating an example of a spreadsheet document change to a timeline of document activity.

FIG. 4B is a user interface rendering illustrating an example of a spreadsheet document summary to a timeline of document activity.

FIG. 4C is a user interface rendering illustrating an example of a spreadsheet document change data to a timeline of document activity.

FIG. 5A is a user interface rendering illustrating an example of a change summary.

FIG. 5B(1) is a user interface rendering illustrating an example of an augmented change summary.

FIG. 5B(2) is a user interface rendering illustrating a example of an augmented change summary with links.

FIG. 5C is a user interface rendering illustrating an example of a group chat for a document.

FIG. 5D is a user interface rendering illustrating an example of an augmented chat.

FIG. 6 is a flow diagram illustrating an embodiment of a process for augmenting a timeline of document changes.

FIG. 7 is a flow diagram illustrating an embodiment of a process for generating search results from a query.

FIG. 8 is a flow diagram illustrating an embodiment of a process for generating search results from proprietary data.

FIG. 9 is a flow diagram illustrating an embodiment of a process for generating search results using a search-tuned LLM.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A timeline of document activity is disclosed. As referred to herein, a document is a computer file and/or any discrete chunk of information, for example a word processor document, a spreadsheet, a slide presentation, an artifact, a group chat, a form, and/or a form response. In one embodiment, a computer network-based document workspace environment such as Google Workspace TM is used to provide a document framework of applications and collaboration, where users log into their Google account, share a document, and change the document, including by adding comments to the document. As referred to herein, document activity comprises any addition, change, and/or deletion of a document's content, metadata, and/or operating system/workspace status. Example of document activity include: an addition of a new user to share a given document; a removal of a sentence in a given document; a document chat entry associated with a given document's chat window; a comment for a given document; a creation of a given document; and a deletion of a given document. As referred to herein, document change is synonymous without limitation to document activity.

Traditionally, a user may use an AI (artificial intelligence) feature based, for example, on an LLM (large language model) to chat with a document. As referred to herein, a chat is any CUI (conversational user interface) that may be text-based, voice-based, and/or video-based that accepts natural language and determines a user's desired system action and/or query. Thus a user provides a query, as referred to herein, as comprising a natural language/chat prompt and/or a search query. In one embodiment, a CUI accepts queries in the form of a natural language “chat” interface that mimics human-to-human chat interfaces such as those for text messaging or SMS (short messaging service) messaging on a mobile phone. A user chatting with a document may for example have the system summarize the document being chatted or look for changes. A challenge with this traditional approach is that a user, for example a supervisor facilitating collaboration amongst knowledge workers, is required to beforehand know generally which documents are in the entire workspace and know which documents are newer and/or more relevant before selecting one to chat with.

Timeline of Summarized Changes. A timeline of summarized changes is disclosed. A timeline of document activity based on changes of a set of documents, for example all documents within a shared folder, is an improvement over this traditional document chat approach. In one embodiment, the timeline is rendered as an “inbox” user interface, similar to what a user is already familiar with in their e-mail inbox, where document changes are presented in reverse chronological order so that recently changed documents are displayed at the top. In one embodiment, a relevance ordering algorithm is used to augment the reverse chronological order with relevance signals for a user such as increasing relevance metrics based on for example whether a document is shared with a user's manager, whether a document is created by the user, whether a document was recently edited by the user, whether a portion of a document recently edited by the user was further edited by another user, and so on.

In one embodiment, document changes are received from an API (application programming interface) such as a version control API that indicates a file has changed. Document changes may also be received by programmatically investigating recent changes in a document including who made the changes and what data/metadata was changed, for example if content has been changed in a document and/or a comment in the document has been added/changed/deleted. Document changes may also be received from a workspace API that indicates a document is newly shared with another user, or that two users are chatting with each other within a document editing environment.

In one embodiment, document changes are communicated as an activity update which provides a summary of multiple changes over the set of documents. In one embodiment, document changes are communicated as an individual change summary of a specific document, which provides a summary of one tranche of changes for one document in the set of documents. In one embodiment, activity updates and/or individual change summaries use an LLM to interpret, summarize and/or contextualize changes using natural language.

LLM Results. As referred to herein, an LLM result is any response from a knowledge retrieval engine such as an AI system or LLM system. A knowledge retrieval engine, as referred to herein, is any system that provides a response to a query. An example of an LLM result would be a natural language summary of document changes. In one embodiment, a first LLM may be used to provide activity updates, while a second LLM may be used to provide individual change summaries, to provide optimal resource cost and benefit given each of the first and second LLM's strengths and challenges. For example, a first LLM providing activity updates may require less resources as it summarizes a plurality of the individual change summary output from a second LLM, in part because the first LLM input has been “pre-chewed” by the second LLM. For example, a first LLM providing activity updates may require more resources as it detects patterns in a plurality of different individual change summaries from a second LLM, in part because the first LLM is more strategic in detection than the second LLM which is focused on tactical changes in a document. In one embodiment, the first LLM and second LLM are the same LLM.

One example use of a timeline is a manager periodically during a day/week observing what many of their managed employees are working on without having to use a word processor, spreadsheet, or slide presentation application software to actually view/edit documents. Another example use of a timeline is an employee interested in changes to documents on their team's documents like a document changed by a manager and/or a peer.

Generating Search Results from Timeline. Generating search results from a timeline of summarized changes is disclosed. As referred to herein, a search result is a piece of content provided in response to a query over a given data set, for example a list of Internet pottery web sites relevant to a query searching for clay bowls. In one embodiment, the given data set is a set of specified data. As referred to herein, a set of specified data is a set of data specified for search, comprising: data from the web, and proprietary data such as customer-owned data or customer-defined data. As referred to herein, proprietary data comprises any data that is unique to and typically owned, licensed, defined, and/or curated by an organization or individual. Proprietary data may include private data, such as pointers, lists, definitions, etc. that defines or otherwise identifies a set of data from non-proprietary sources.

Providing search results relevant to shared documents improves collaboration by providing additional insight and/or context drawn from resources such as the web data and/or proprietary data. As referred to herein, the web refers without limitation to the Internet and web data as referred to herein includes data retrievable on the Internet, whether by Hypertext Transfer Protocol (HTTP) or other protocols, and over computer interfaces or mobile interfaces such as LAN, WiFi and/or 5G. In one embodiment, relevance metrics are used to prioritize search results based on a user's settings, past history/context, and/or selected documents a user selects to view details on. As referred to herein, a relevance metric is any measure used to grade and/or evaluate how well an information retrieval system meets a user's needs by returning relevant results.

In one embodiment, an activity update is augmented with generated search results to provide a seamless augmented summary of multiple changes over the set of documents. As referred to herein, to augment comprises any addition of context and/or relevant content such as a summary, a graphic, and/or cross-references such as links. For example, a few documents in a corporate workspace have been updated to include a new employee, including a salary table, an org chart, and a contact list. A search result for the new employee may include a social media profile such as a LinkedIn TM profile. The activity update may describe onboarding the new employee and also give a brief bio based in part on the generated search results. In one embodiment, the search results are provided in an extended footnote for a user to click through and get more details from the web data and/or customer-owned data, for example the LinkedIn profile.

In one embodiment, an individual change summary is augmented with generated search results to provide a seamless augmented summary of changes for the individual document. For example, a blog has been updated with a new blog entry about an accident that just occurred. When the timeline user checks their inbox at a later time, a search result for the accident may include updated information about a current injury count for the accident based on a news article. The individual change summary may describe the new blog entry on the accident and give more current updates such as injury counts based in part on the generated search results. In one embodiment, the search results are provided in an extended footnote and/or cross-reference for a user to click through and get more details from the web data and/or customer-owned data, for example the news article.

In one embodiment, an activity update and/or an individual change summary is organized to be filtered, sorted, searched, and/or selected by the user. For example a user may filter one or more of the following: unread/read activity, favorite files, activity created by the user themselves, activity shared with the user, new activity in the last 7 days, activity within the workspace/drive of the user themselves, and activity within a workspace/drive shared with the user. In one embodiment, a plurality of activity updates and/or individual change summaries may be ordered and/or hidden according to a relevance metric for the particular user, when first presented in the timeline.

In one embodiment, the activity update is personalized to each user according to their documents, the portions of the documents accessible to them, and/or the frequency they check the timeline. In one embodiment, the individual change summary is atomic in the sense that the same individual change summary is used for a document change independent of the user viewing the individual change summary. In one embodiment, the activity update is a summary of the individual change summaries relevant for a particular user.

Multi-document Chat. A chat or CUI to summarize and/or query a plurality of documents selected using the timeline is disclosed. A chat/CUI interface permits a user to query a document in a natural language, for example to ask it to summarize aspects of itself and/or inquire about details of a summary. Chatting with multiple documents enables the improvement of being able to answer queries that aggregate information across documents. The chat/CUI with a plurality of documents also has the improvement that it is further augmented with a context of a chat history.

For example, after an enterprise-wide change, chatting with multiple documents may permit an answer that summarizes all the different salary table spreadsheets from different departments to answer a question about salary distributions across departments in comparison to industry standards retrieved by generated augmented search. For example, after a change to a salary table spreadsheet and an org chart presentation, chatting with both documents enables an answer to a question about manager salaries across an enterprise in comparison to industry standards retrieved by generated augmented search. For example, if an engineer is revising multiple internal documentation using a word processor app and a slide presentation app for a new hardware platform, the engineer's manager may chat with all the changed documents to supervise the revision and pick out inconsistencies or missed documents.

Relevance Metric. In one embodiment, an activity update and/or an individual change summary is assessed for relevance based at least in part to one or more of the following: relevance to a specific user, relevance to a group of users, relevance to an enterprise, relevance to a mission, relevance to an activity importance, relevance to an activity frequency, and relevant to an activity history. For example, an activity involving a change to formatting in a slide presentation may be less relevant than an activity involving a change to a formula in a spreadsheet. In one embodiment, an LLM is used to at least partially assess the relevance metric for a given activity update and/or individual change summary. In one embodiment, the relevance metric is given a quantitative value which is used for sorting, filtering, and/or is displayed beside each activity update and/or individual change summary.

Multimodal LLM. In one embodiment, the LLM responsible for the individual change summary is a multimodal LLM capable, for example, of recognizing illustrations, hand-drawn pictures, hand-drawn annotations/comments, music/lyrics, environmental noise, and/or speech.

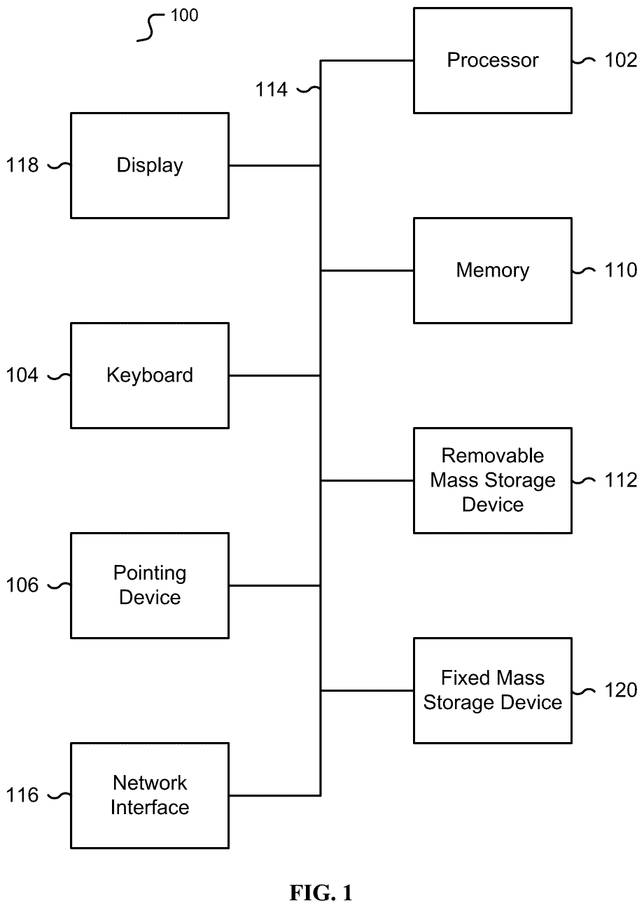

FIG. 1 is a functional diagram illustrating a programmed computer/server system for facilitating a timeline of document activity in accordance with some embodiments. As shown, FIG. 1 provides a functional diagram of a general-purpose computer system programmed to facilitate a timeline of document activity accordance with some embodiments. As will be apparent, other computer system architectures and configurations can be used for facilitating a timeline of document activity.

Computer system 100, which includes various subsystems as described below, includes at least one microprocessor subsystem, also referred to as a processor or a central processing unit (“CPU”) 102. For example, processor 102 can be implemented by a single-chip processor or by multiple cores and/or processors. In some embodiments, processor 102 is a general purpose digital processor that controls the operation of the computer system 100. Using instructions retrieved from memory 110, the processor 102 controls the reception and manipulation of input data, and the output and display of data on output devices, for example display and graphics processing unit (GPU) 118.

Processor 102 is coupled bi-directionally with memory 110, which can include a first primary storage, typically a random-access memory (“RAM”), and a second primary storage area, typically a read-only memory (“ROM”). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 102. Also as well known in the art, primary storage typically includes basic operating instructions, program code, data, and objects used by the processor 102 to perform its functions, for example, programmed instructions. For example, primary storage devices 110 can include any suitable computer-readable storage media, described below, depending on whether, for example, data access needs to be bi-directional or uni-directional. For example, processor 102 can also directly and very rapidly retrieve and store frequently needed data in a cache memory, not shown. The processor 102 may also include a coprocessor (not shown) as a supplemental processing component to aid the processor and/or memory 110.

A removable mass storage device 112 provides additional data storage capacity for the computer system 100, and is coupled either bi-directionally (read/write) or uni-directionally (read-only) to processor 102. For example, storage 112 can also include computer-readable media such as flash memory, portable mass storage devices, holographic storage devices, magnetic devices, magneto-optical devices, optical devices, and other storage devices. A fixed mass storage 120 can also, for example, provide additional data storage capacity. One example of mass storage 120 is an eMMC or microSD device. In one embodiment, mass storage 120 is a solid-state drive connected by a bus 114. Mass storages 112, 120 generally store additional programming instructions, data, and the like that typically are not in active use by the processor 102. It will be appreciated that the information retained within mass storages 112, 120 can be incorporated, if needed, in standard fashion as part of primary storage 110, for example RAM, as virtual memory.

In addition to providing processor 102 access to storage subsystems, bus 114 can be used to provide access to other subsystems and devices as well. As shown, these can include a display monitor 118, a communication interface 116, a touch (or physical) keyboard 104, and one or more auxiliary input/output devices 106 including an audio interface, a sound card, microphone, audio port, audio input device, audio card, speakers, a touch (or pointing) device, and/or other subsystems as needed. Besides a touch screen, the auxiliary device 106 can be a mouse, stylus, track ball, or tablet, and is useful for interacting with a graphical user interface.

The communication interface 116 allows processor 102 to be coupled to another computer, computer network, or telecommunications network using a network connection as shown. For example, through the communication interface 116, the processor 102 can receive information, for example data objects or program instructions, from another network, or output information to another network in the course of performing method/process steps. Information, often represented as a sequence of instructions to be executed on a processor, can be received from and outputted to another network. An interface card or similar device and appropriate software implemented by, for example executed/performed on, processor 102 can be used to connect the computer system 100 to an external network and transfer data according to standard protocols. For example, various process embodiments disclosed herein can be executed on processor 102, or can be performed across a network such as the Internet, intranet networks, or local area networks, in conjunction with a remote processor that shares a portion of the processing. Throughout this specification, “network” refers to any interconnection between computer components including the Internet, Bluetooth, WiFi, 3G, 4G, 4GLTE, GSM, Ethernet, intranet, local-area network (“LAN”), home-area network (“HAN”), serial connection, parallel connection, wide-area network (“WAN”), Fibre Channel, PCI/PCI-X, AGP, VLbus, PCI Express, Expresscard, Infiniband, ACCESS. bus, Wireless LAN, HomePNA, Optical Fibre, G. hn, infrared network, satellite network, microwave network, cellular network, virtual private network (“VPN”), Universal Serial Bus (“USB”), FireWire, Serial ATA, 1-Wire, UNI/O, or any form of connecting homogenous and/or heterogeneous systems and/or groups of systems together. Additional mass storage devices, not shown, can also be connected to processor 102 through communication interface 116.

An auxiliary I/O device interface, not shown, can be used in conjunction with computer system 100. The auxiliary I/O device interface can include general and customized interfaces that allow the processor 102 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: flash media such as NAND flash, eMMC, SD, compact flash; magnetic media such as hard disks, floppy disks, and magnetic tape; optical media such as CD-ROM disks; magneto-optical media such as optical disks; and specially configured hardware devices such as application-specific integrated circuits (“ASIC”s), programmable logic devices (“PLD”s), and ROM and RAM devices. Examples of program code include both machine code, as produced, for example, by a compiler, or files containing higher level code, for example a script, that can be executed using an interpreter.

The computer/server system shown in FIG. 1 is but an example of a computer system suitable for use with the various embodiments disclosed herein. Other computer systems suitable for such use can include additional or fewer subsystems. In addition, bus 114 is illustrative of any interconnection scheme serving to link the subsystems. Other computer architectures having different configurations of subsystems can also be utilized.

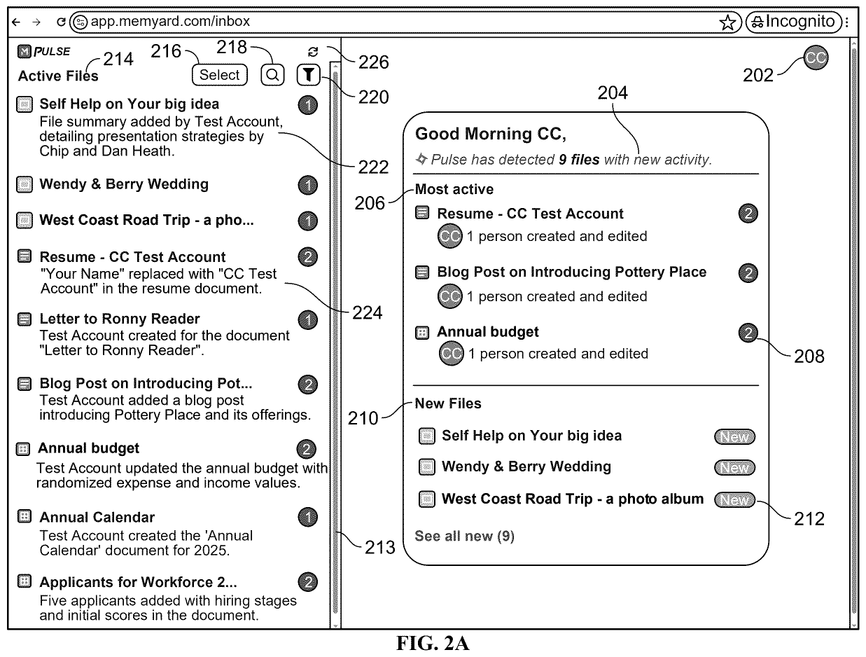

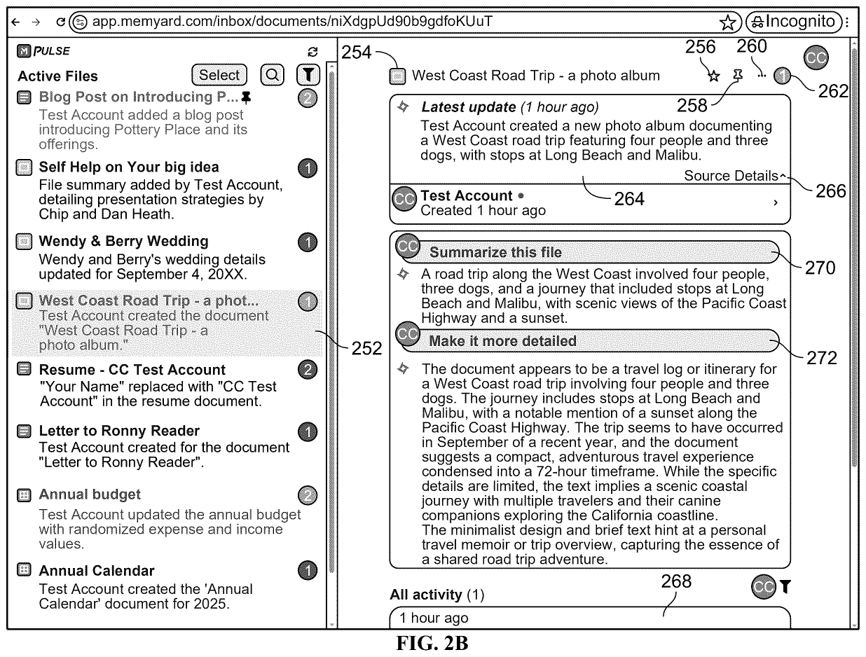

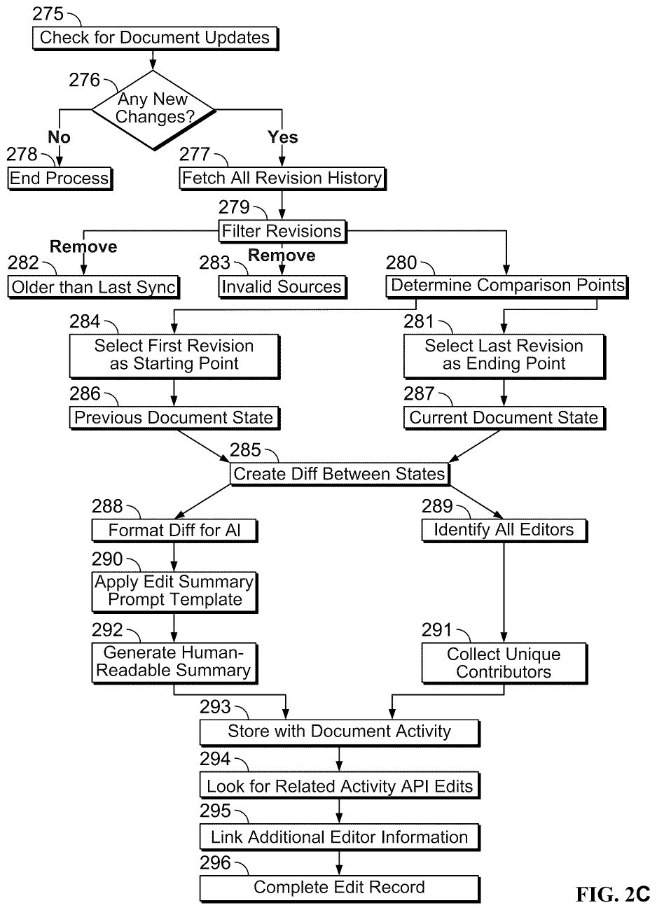

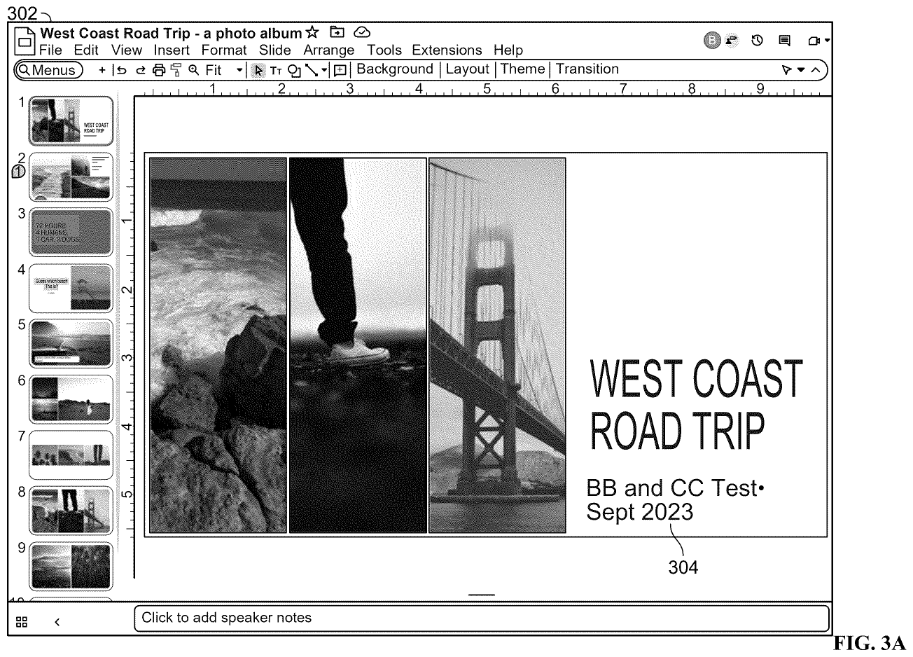

FIG. 2A is a user interface rendering illustrating an initial example of a timeline of document activity. In one embodiment, the user interface rendering shown in FIG. 2A is rendered by the system of FIG. 1.

A user with a profile (202) is initially greeted in the rendering with an indication of the number of documents with new activity (204), in the example in FIG. 2A nine documents are indicated with new activity. Such activity includes most active documents (206) which is a shortlist of active documents, sorted by an activity metric such as the number of changes including a user creating a file and a user editing. In one embodiment, this shortlist is sorted and/or filtered by a relevance metric. One example of an entry in the shortlist is as annual budget in the example in FIG. 2A (208) with two changes, which is one person who created and the same person edited. Another example of three changes might be three separate people changing an existing document or one person changing it over three periods of time such as morning, afternoon, and evening. Other activity (204) includes new files (210), an example given in FIG. 2A (212) is a photo album of a coastal road trip.

In one embodiment, in the activity update (204), not shown in FIG. 2A, is a multi-document summary such as: “CC has been updating their resume with their latest marketing promotion at the Pottery Place, editing the Pottery Place annual budget by noting the increase in their compensation under the marketing expenses, and describing Pottery Place in a marketing blog post.” In one embodiment, the multi-document summary is generated by an LLM processing all document activity generated by the workspace API.

In one embodiment, in the activity update (204), not shown in FIG. 2A, the multi-document summary is used to generate a set of search results that is derived at least in part from a set of change and/or specified data. The set of search results comprise search results within a set of customer-owned data/proprietary data, and/or web search results. As referred to herein, a web search engine is any system that provides hyperlinks to web and/or internet content in response to a user query. The web search engine provides web search results and may be a standalone/external system and/or an internal subsystem. The set of search results may be used to augment the change data as displayed via the user interface, for example: “CC has been updating their resume with their latest marketing promotion at the second largest home and furnishings store, Pottery Place [1], editing the Pottery Place annual budget by noting the increase in their compensation under the marketing expenses which is above average for the industry [2], and describing Pottery Place in a marketing blog post,” with cross references [1] leading to a web link of the Wikipedia TM entry for Pottery Place and [2] leading to a web link of a business article on marketing budgets for the industry.

One example of proprietary data is customer-owned data such as a customer's internal files or knowledge bases. A service provider may have a plurality of customers, and each customer may have customer-owned data. The service provider may provide a service that uses a customer's customer-owned data. Typically, care is taken to use a given customer's data only for the benefit of that customer. One example of proprietary data is customer-defined data, for example customer curated data such as that for a zoological department at a university that includes a set of concepts and terminology for a specific field of zoology.

In one embodiment, augmenting the change data with the set of search results based on proprietary data uses an LLM, such as a fine-tuned LLM. The fine-tuned LLM may without limitation be any pre-trained LLM that has been retrained on a dataset associated with proprietary data. Examples of a fine-tuned LLM include without limitation: an unsupervised fine-tuned LLM; a supervised fine-tuned LLM; a human feedback fine-tuned LLM using for example an RLHF (Reinforcement Learning From Human Feedback) technique; and/or a parameter reduced fine-tuned LLM using for example a PEFT (Parameter-Efficient Fine-Tuning) technique and/or LoRA (Low-Rank Adaptation) technique. In one embodiment, the fine-tuned LLM is a model that stores proprietary information in a secure way. In one embodiment, the fine-tuned LLM is a model that stores proprietary information to address a privacy concern and/or confidentiality concern.

In the example shown in FIG. 2A, in another section (213) of the timeline user interface a list of all active documents (214) is rendered. The list of active documents may be selected (216) for example to be selected for archiving, to be “pinned”, or to be flagged as a “favorite”. In one embodiment, archiving a document removes the document from the timeline to be accessed from a separate timeline of archived documents. In one embodiment, a pinned document remains at the top of any sorted list of documents. In one embodiment, a favorite document is a way for a user to manually flag documents for sorting and/or filtering as having a higher relevance metric than otherwise may be assigned.

In the example shown in FIG. 2A, the list of active documents may be searched (218), for example by file name, shared users, creation date, last modified date, and/or by size. The list of active documents may be filtered (220), for example by unread/read activity, favorite files, activity created by the user themselves, activity shared with the user, new activity in the last 7 days, activity within the workspace/drive of the user themselves, and/or activity within a workspace/drive shared with the user.

In the example shown in FIG. 2A, examples of active documents include a slide presentation on shelf help (222) which has an individual change summary of “File summary added by Test Account, detailing presentation strategies . . . ” and a change count of one, and a document with a resume for the user (224) which has an individual change summary of “‘Your name’replaced with “CC Test Account” in the resume document” and a change count of two. The change count indicates how many tranches of changes have occurred in that document since the last time it was viewed from the timeline. In one embodiment, a refresh UI (user interface) element (226) is used to manually trigger the revision API for document activity beyond a nominal frequency, for example once every five minutes.

In one embodiment not shown in FIG. 2A, a chat UI element may be provided for the user to initiate a chat with one or more documents, for example those in active files (214) or other documents, in a multi-document CUI as described above.

FIG. 2B is a user interface rendering illustrating a document example of a timeline of document activity. In one embodiment, the user interface rendering shown in FIG. 2B is rendered by the system of FIG. 1.

A user with user interface rendering similar to that of FIG. 2A may select an active file such as the photo album of a coastal road trip (252). In another section of the timeline user interface (254) a document detail is rendered. This may include options to “favorite” (256), “pin” (258), or an ellipsis may indicate other options such as archival of the document from the timeline or an option to launch the document using an associated app such as a slide app for a presentation. The document detail (254) may also include a change count (262).

In one embodiment, the document detail (254) displays an individual change summary, for example the latest update (264) which may be generated for example by using an LLM based on input from a workspace revision API. The latest update may have a cross-reference (266) to show the source details, which is partially rendered in FIG. 2B (268) to show more detail on the update along with a raw rendering of the workspace revision API entry that the update is based on, for example a mechanical “diff” data comparison.

In one embodiment, the document detail (254) displays an option to summarize the document itself (270), which may summarize the changed document using an LLM based on input from the document itself. A “more detailed” option (272) may be available to request an LLM to provide more details on the summary.

FIG. 2C is a flow diagram illustrating an embodiment of a process for providing a timeline of document changes. In one embodiment, the process of FIG. 2C is carried out by the system of FIG. 1. In one embodiment, the process of FIG. 2C is rendered for example by the screen shots in FIG. 2A and FIG. 2B.

In step (275), the system regularly checks for documents modified since the last check/sync. This may be done using, for example, an API provided by the workspace provider. For example, for a cloud-based workspace provider like Google Drive TM, the Google Drive API may be checked for new documents modified.

In step (276), if there are no new changes, control is transferred to step (278) and the check ends. Otherwise, control is transferred to step (277) and when a modified document is found, the system examines its revision history. Any available revision history may be collected using, for example, an API provided by the workspace provider, for example the Google Drive API and/or Google Drive Activity API. In one embodiment, each revision includes who made it and when.

In step (279) the list of revisions are filtered, so that revisions created before the last check/sync in step (282) are removed, revisions from invalid sources (283) are removed, effectively filtering out revisions suitable to determine comparison points (280). The system intelligently selects two key versions to compare: the starting point/oldest relevant revision, that is, the first in the filtered list (284) in relation to the previous document state (286) at the previous sync; and the ending point/newest revision, that is the last in the filtered list (281) in relation to the current document state (287) now. Such an approach captures any changes made between checks in one summary.

In step (285), the comparison is created in part as the system compares the content between the two starting point/ending point versions, by creating a diff between the states to identify what text/graphics/hypertext/media was added, removed, and/or changed. The diff may be summarized, for example using an LLM (288), and an edit summary prompt template applied (290) to generate a human-readable summary (292). All users and/or editors are identified (289) and unique contributors are collected (291). The summary and contributors are stored with document activity (293). These edits may be correlated using, for example, an API provided by the workspace provider, for example the Google Drive and/or Google Drive Activity API, to further investigate from the “operating system” side by fetching all workspace edits to look for related activity API edits in step (294), and linking each edit from, for example, the Google Drive Activity API to the closest, for example using the metric of last modified time, to an edit created from, for example, the Google Drive API (295). This may be used for multi-attribution, which is referred to herein as groups of edits that are made by multiple authors. This completes the edit record (296).

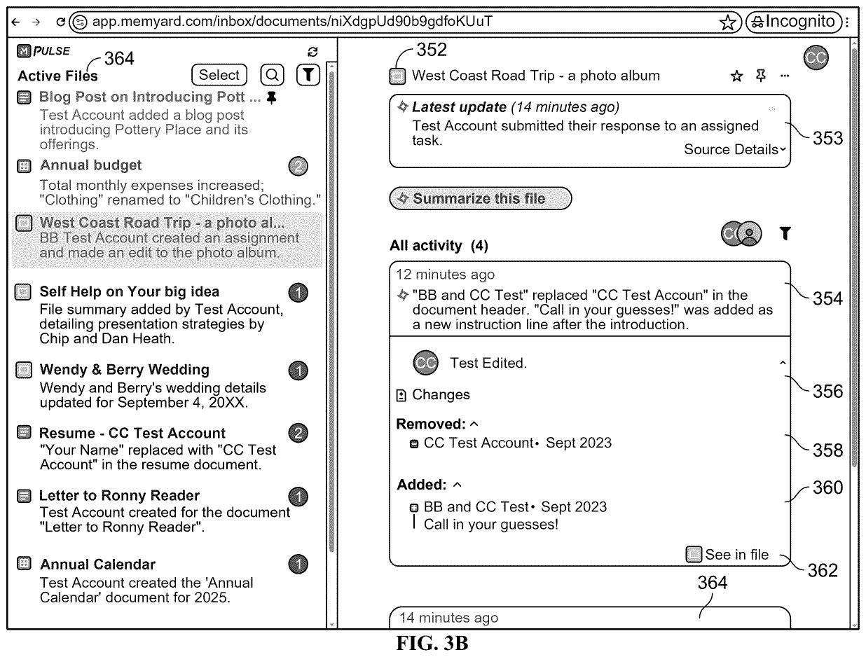

FIG. 3A is a screenshot illustration of an example of a document change. As an example, the document edited in FIG. 3A is the same document described in FIG. 2B. In the example of FIG. 3A, one user named Test Account has made an edit to a slide document via a slide app (302) by changing the cover page authorship from “CC Test Account” to “BB and CC Test” (304).

FIG. 3B is a user interface rendering illustrating an example of a slide document change to a timeline of document activity. In one embodiment, the user interface rendering shown in FIG. 3B is rendered by the system of FIG. 1. As an example, the document edited in FIG. 3A has affected the timeline of document activity as shown in FIG. 3B.

The user has selected the same document (352) with the activity update called “latest update” (353) and an individual change summary (354) states in part that 12 minutes ago from the time the snapshot is taken in FIG. 3B, “‘BB and CC Test’ replaced ‘CC Test Account’ in the document header.” A UI element (356) indicating the name of the user, Test, who made the change, and an expand UI element is provided to provide further details of the change. When asserted, the further details of the change include the removal (356) of text “CC Test Account·September 2023” and the addition (360) in part of text “BB and CC Test·September 2023”. A UI element (362) may be provided to see the changes in file using the associated app for the document, in this case a slide presentation app. The next individual change summary (364) describes what happened 14 minutes ago from the time the snapshot is taken in FIG. 3B.

In one embodiment not shown in FIG. 3B, the change data (358) and/or (360) is used to generate a set of search results that is derived at least in part from a set of specified data. The set of search results is used to augment the change data as displayed in the user interface. For example, the individual change summary (354) shown in FIG. 3B “‘BB and CC Test’ replaced ‘CC Test Account’ in the document header” may be augmented with web data with this sentence “‘BB and CC Test’ replaced ‘CC Test Account’ in the document header. BB is a popular TikTok TM influencer in coastal communities [1]” with a cross-reference “[1] BB's TikTok Profile Page”.

In one embodiment not shown in FIG. 3B, the document (352) user interface includes a chat UI element to initiate a CUI for the document. A user chatting with a document may for example have the system summarize the document being chatted or look for changes. The chat UI element may also have an option to include additional documents, for example those in active files (364) or other documents, to chat with in a multi-document CUI as described above.

Search-tuned LLM. As described above, an LLM is used to provide a natural language summary such as an Activity Update (353) in FIG. 3B or Individual Change Summary (354) in FIG. 3B. Using an LLM tuned for search is disclosed. As described herein, a search-tuned LLM is an LLM using a different prompt from the LLM used to provide a natural language summary, the output of which is specifically optimized to be a better web query or better internal proprietary database query than using an Activity Update or Individual Change Summary may be.

The improvement of this approach includes better search results, in at least these four cases:
Groups of changes used to generate search-tuned LLM results which are used to generate web results. For example, in FIG. 3B, the 12 minutes ago Individual Change Summary (354) and 14 minutes ago Individual Change Summary (364) or the document activity underlying them may be fed together to the search-tuned LLM to generate a better web query than using the “Latest update” Activity Update (353) as the query;
Groups of changes used to generate search-tuned LLM results which are used to generate search results from customer-owned data. For example, in FIG. 3B, the 12 minutes ago Individual Change Summary (354) and 14 minutes ago Individual Change Summary (364) or the document activity underlying them may be fed together to the search-tuned LLM to generate a better internal proprietary data query than using the “Latest update” Activity Update (353) as the query;
Individual changes used to generate search-tuned LLM results which are used to generate web results. For example, in FIG. 3B, the 12 minutes ago Individual Change Summary (354) or the underlying document activity may be fed to the search-tuned LLM to generate a better web query than using the Individual Change Summary (354) as the query; and/or
Individual changes used to generate search-tuned LLM results which are used to generate search results from customer-owned data. For example, in FIG. 3B, the 12 minutes ago Individual Change Summary (354) or the underlying document activity may be fed to the search-tuned LLM to generate a better internal proprietary data query than using the Individual Change Summary (354) as the query.

In addition to simply using a different prompt, a search-tuned LLM may without limitation be any pre-trained LLM that has been retrained on a proprietary dataset and/or used with a prompt template. Examples of a search-tuned LLM include without limitation: an unsupervised fine-tuned LLM; a supervised fine-tuned LLM; a human feedback fine-tuned LLM using for example an RLHF (Reinforcement Learning From Human Feedback) technique; and/or a parameter reduced fine-tuned LLM using for example a PEFT (Parameter-Efficient Fine-Tuning) technique and/or LoRA (Low-Rank Adaptation) technique. In one embodiment, the search-tuned LLM is a model that stores proprietary information in a secure way. In one embodiment, the search-tuned LLM is a model that stores proprietary information to address a privacy concern and/or confidentiality concern.

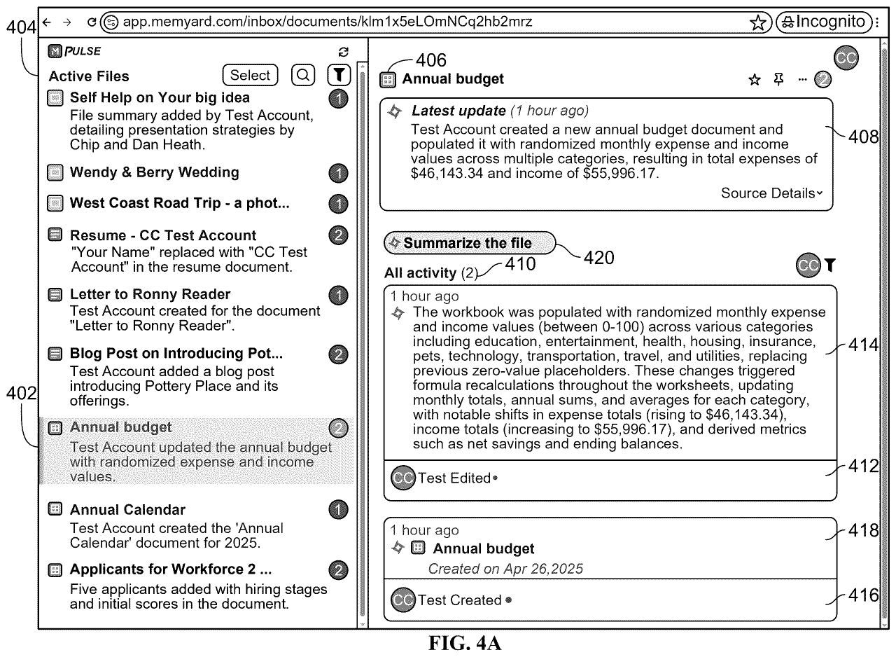

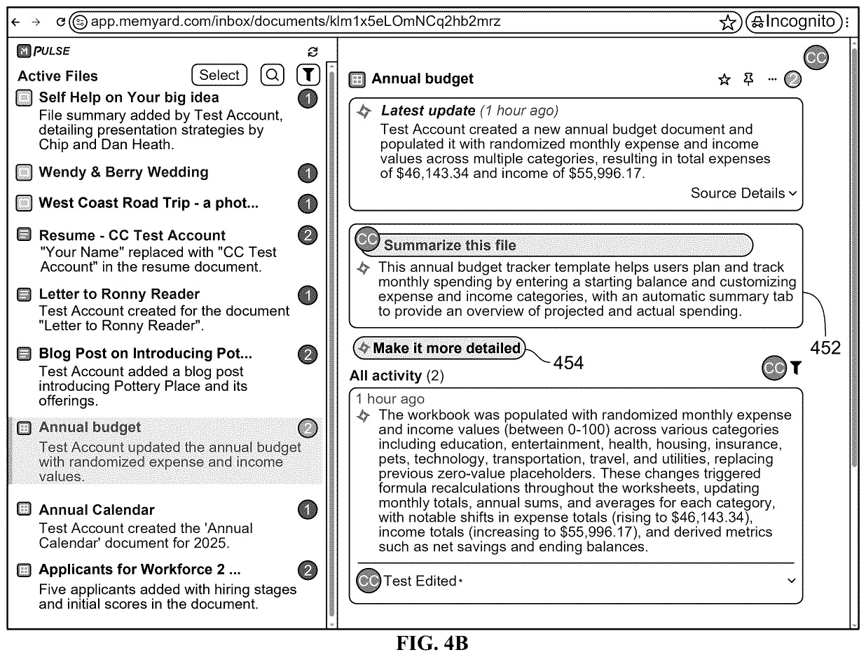

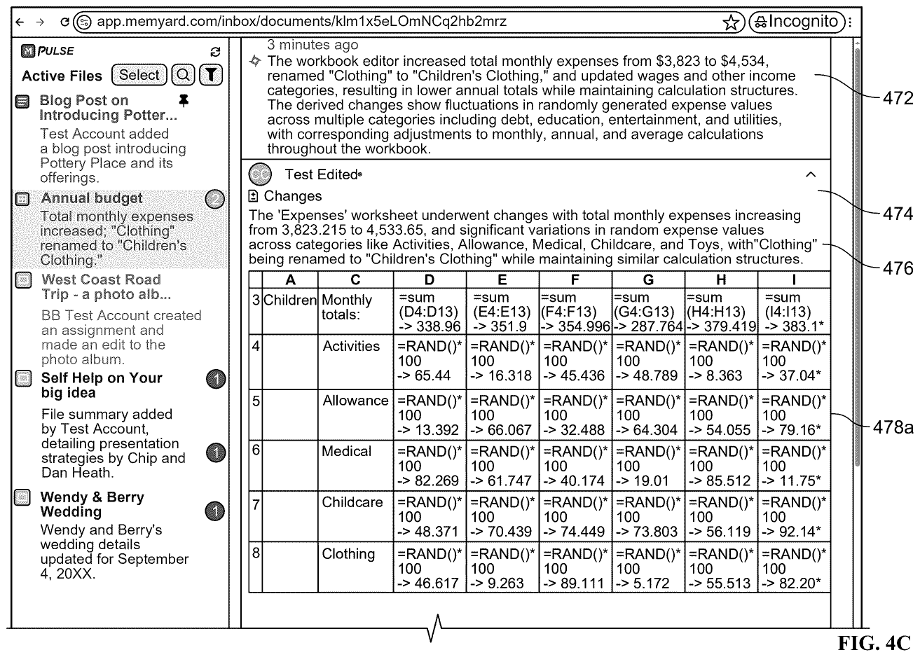

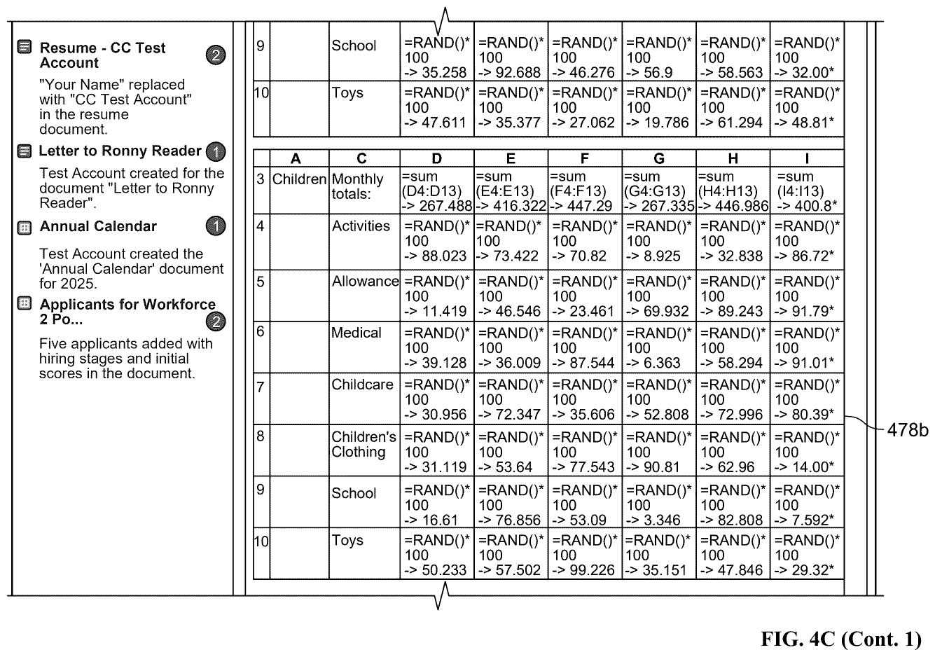

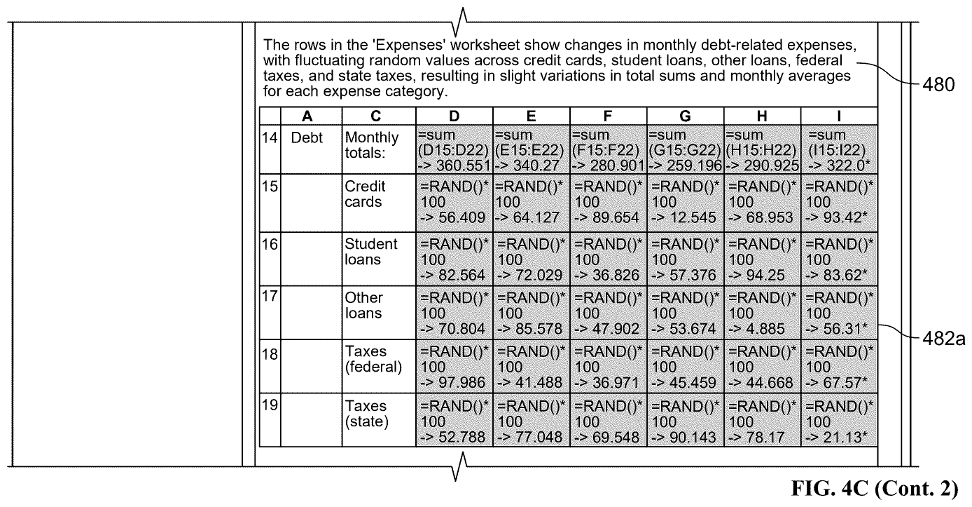

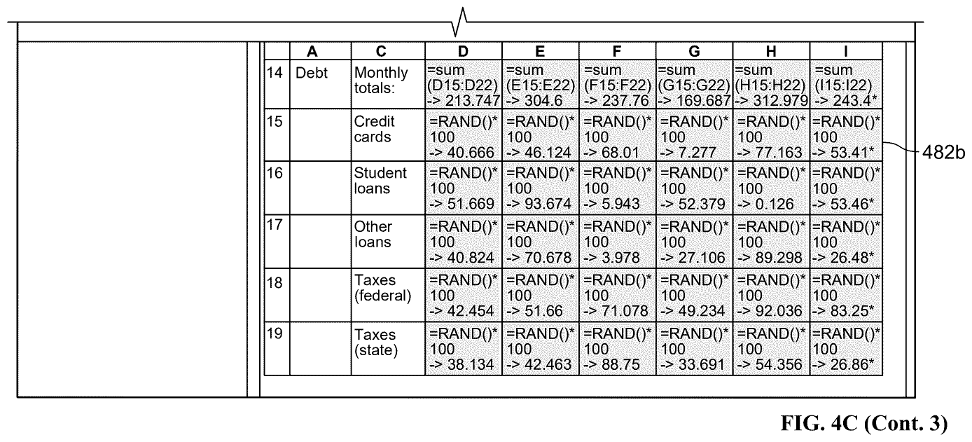

FIG. 4A is a user interface rendering illustrating an example of a spreadsheet document change to a timeline of document activity. In one embodiment, the user interface rendering shown in FIG. 4A is rendered by the system of FIG. 1.

In the timeline of document activity, the user has selected a spreadsheet document called “Annual budget” (402) with a change count of two in the list of active documents (404), so that the focus of the timeline is this Annual budget (406). An individual change summary (408) states that “Test Account created a new annual budget and populated it with randomized monthly expense and income values across multiple categories, resulting in total expenses of $46,1453.34 and income of $55,996.17” in the latest update.

For all activity (410) which comprises the two changes, in reverse chronological order there is a first change that Test Account edited (412) that describes with more detail the individual change (414): “The workbook was populated with randomized monthly expense and income values (between 0-100) across various categories including education, entertainment, health, housing, insurance, pets, technology, transportation, travel, and utilities, replacing previous zero-value placeholders. These changes triggered formula recalculations throughout the worksheets, updating monthly totals, annual sums, and averages for each category, with notable shifts in expense totals (rising to $46,143.34), income totals (increasing to $55,996.17), and derived metrics such as net savings and ending balances.” There is also a second change that Test Account created (416) the document which shows in detail (418) that the document was created on Apr. 26, 2025.

In one embodiment not shown in FIG. 4A, the underlying change data for (414) is used to generate a set of search results that is derived at least in part from a set of specified data. The set of search results is used to augment the change data as displayed in the user interface. For example, the individual change summary (414) shown in FIG. 4A may be augmented with company-owned data with an additional sentence “This edit follows the company's ISO 9001 standard operating procedure to stress test the budget worksheet after creation [1]” with a footnote “[1] ISO 9001 Section 32.1 Budget Worksheet Creation Testing” within the corporation's internal intranet.

In one embodiment not shown in FIG. 4A, the document (406) user interface includes a chat UI element to initiate a CUI for the document. A user chatting with a document may for example have the system summarize the document being chatted or look for changes. The chat UI element may also have an option to include additional documents, for example those in active files (404) or other documents, to chat with in a multi-document CUI as described above.

FIG. 4B is a user interface rendering illustrating an example of a spreadsheet document summary to a timeline of document activity. In one embodiment, the user interface rendering shown in FIG. 4B is rendered by the system of FIG. 1. As an example, the document in FIG. 4A has had a summarize UI element asserted (420) prior to the rendering shown in FIG. 4B.

As shown in FIG. 4B, after the summarize UI element (420) is asserted in FIG. 4A to “summarize the file”, an LLM is used to generate a file summary (452): “This annual budget tracker template helps users plan and track monthly spending by entering a starting balance and customizing expense and income categories, with an automatic summary tab to provide an overview of projected and actual spending.” And additional detailed summary UI element (454) is provided to allow the user to request even more detail on the document itself.

FIG. 4C is a user interface rendering illustrating an example of a spreadsheet document change data to a timeline of document activity. In one embodiment, the user interface rendering shown in FIG. 4C is rendered by the system of FIG. 1. As an example, the document in FIG. 4A has had an additional change added prior to the rendering shown in FIG. 4C.

As shown in FIG. 4C, an individual change summary (472) is generated, for example using an LLM, that states “The workbook editor increased total monthly expenses from $3,823 to $4,534, renamed ‘Clothing’ to ‘Children's Clothing,’ and updated wages and other income categories, resulting in lower annual totals while maintain calculation structures. The derived changes show fluctuations in randomly generated expense values across multiple categories including debt, education, entertainment, and utilities, with corresponding adjustments to monthly, annual, and average calculations throughout the workbook.”

When a user asserts a UI element (474) to view the underlying document change data for the individual change summary, the change data rendered in the UI may include one or more generated paragraphs (476)/(480), for example via an LLM, to describe specific change data points. As shown in FIG. 4C, a first change data (476) prior to change is shown in a first table (478a) and the data after the change, including the rename to Children's Clothing, is shown in a second table (478b). A second change data (480) prior to change is shown in a third table (482a) and the data after the change is shown in a fourth table (482b).

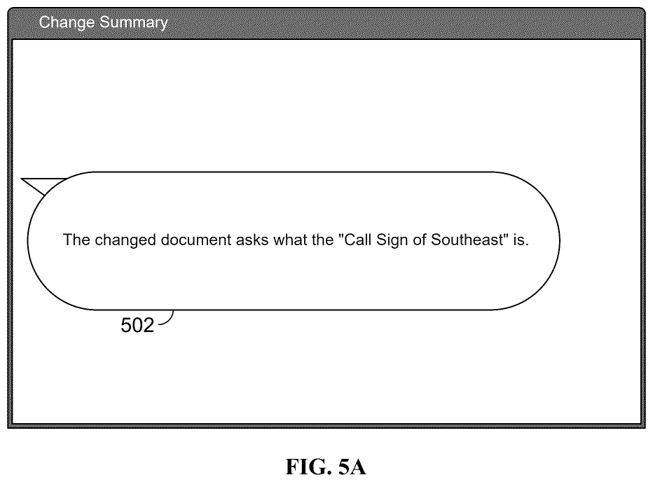

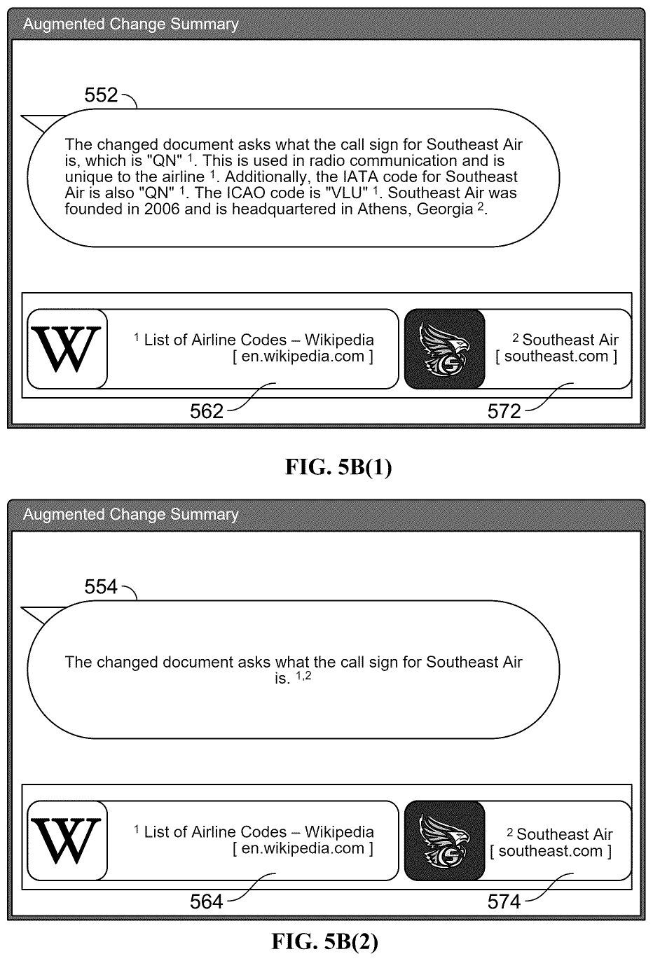

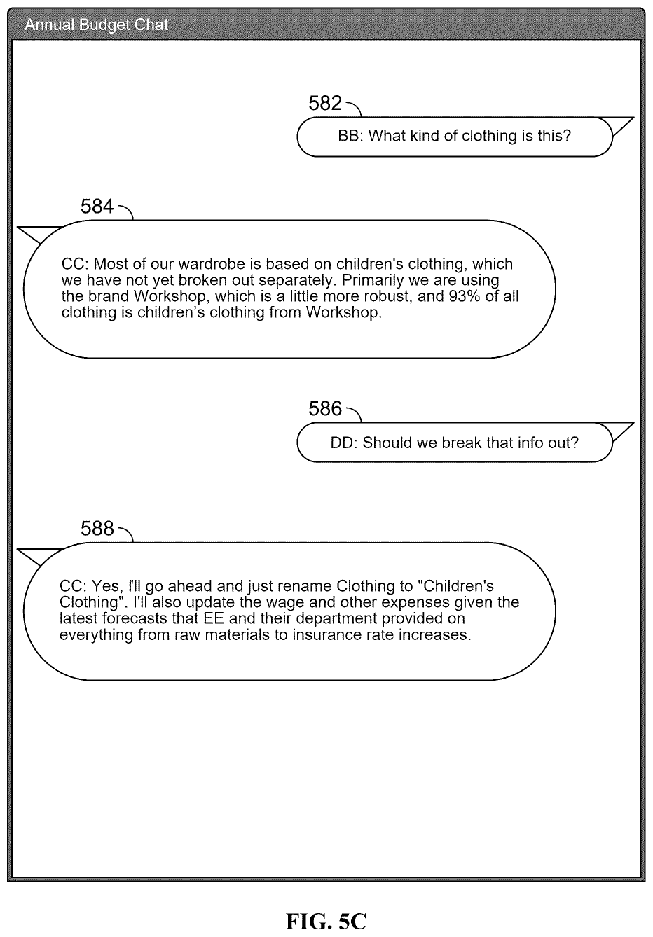

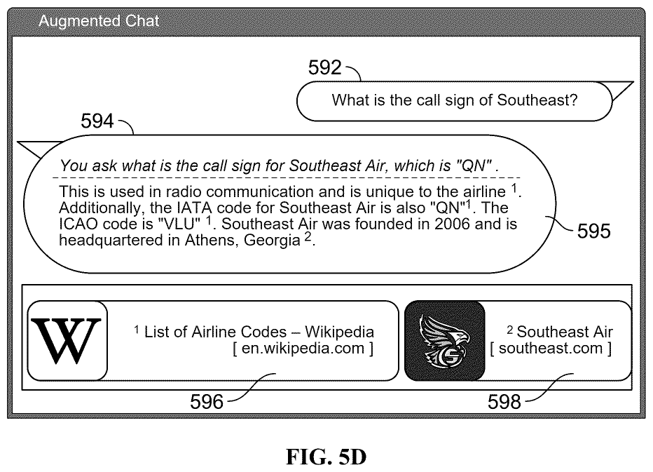

FIG. 5A is a user interface rendering illustrating an example of a change summary. In one embodiment, the user interface rendering shown in FIG. 5A is rendered by the system of FIG. 1, and a simplification of the renderings shown in FIGS. 2A through 4C.

The UI rendering of FIG. 5A is that of the change summary (502) which may be an individual change summary of a single document or activity update over a set of documents. In one embodiment not shown, a similar rendering in FIG. 5A may take place with a chatbot or CUI to allow a user to query a single document or set of documents. In the example of FIG. 5A, a change summary involves an individual document or set of documents that introduce a question for what the call sign is for Southeast, to reference an imaginary illustrative airline called Southeast Air. In the example of FIG. 5A, an LLM summarizing the change may not appropriately recognize the natural language term “Southeast”, perhaps interpreting it to be an ordinal direction on a compass or a geographic/cultural region of a country, and so the summary of the change is simply that “the document asks what the ‘Call Sign of Southeast’is”.

FIG. 5B(1) is a user interface rendering illustrating an example of an augmented change summary. In one embodiment, the user interface rendering shown in FIG. 5B(1) is rendered by the system of FIG. 1. The user interface rendering shown in FIG. 5B(1) is meant to contrast that of FIG. 5A using specified data, for example proprietary data, customer-owned data, customer-defined data, and/or web data. For the illustrative purposes of the example in FIG. 5B(1), the specified data of FIG. 5B(1) is that of an airlines management consulting organization, so that customer-owned/customer-defined data includes an intranet and database of airline companies. As shown in FIG. 5B(1), specified data may include combinations of proprietary data, customer-defined data, customer-owned data, and web data.

Similar to that in FIG. 5A, an individual document change and/or activity update over a set of documents references “What is the call sign of Southeast?”. Unlike in FIG. 5A, natural language term “Southeast” is better recognized using the proprietary data of the airlines management consulting enterprise as it establishes airline companies as a context. Improvements of augmenting change data include less user time and resource space required, and decreases in computing resources such as processing, memory, storage, and/or networking resources for change data display in that it provides a richer summary that makes better use of a user's resources.

The change summary (552) is augmented, referred to herein as a change summary with additional contextual content associated with specified data. In one embodiment, output from (1) an LLM results/search results from proprietary data and/or (2) web search results is run with the change summary through another LLM to provide the augmented change summary (552). In the example of FIG. 5B(1), the augmented change summary is that the call sign for Southeast Air is QN, the IATA code for Southeast Air is QN, and the ICAO code is VLU. In the example of FIG. 5B(1), the augmented change summary includes a description of a call sign as “used in radio communication and is unique to the airline”, that Southeast was founded in 2006, and the location of its headquarters. In one embodiment, the query response includes web search results as a set of two cross-references and/or footnotes.

In the example of FIG. 5B(1), proprietary data such as customer-owned data is used via a search result to establish context that “Southeast” refers to an airlines. In the example of FIG. 5B(1), web data is used to provide web search results to enrich the summary and add cross-references and/or footnotes. In one embodiment, web search results are cross-referenced in the change summary, for example and without limitation as shown in response by footnotes in FIG. 5B(1). For example, a first footnote references a first web search result as a Wikipedia article (562), and a second footnote references a second web search result as a corporate website for Southeast Air (572).

That is, the change summary is contextualized in part using a search engine over proprietary data which clarifies that “Southeast” is the Southeast Air company referred to, what industry they are in, and/or what their full name is. By contrast, a straight web search deals with added ambiguity, such as whether “Southeast” is a direction or a company, what is the company name, what industry are they in. The augmentation reduces the ambiguity of the change summary and/or chat query or prompt given, transforming that before rendering the change summary. An improvement is thus less ambiguity and/or more specific/better matches from the change summary.

FIG. 5B(2) is a user interface rendering illustrating a example of an augmented change summary with links. In one embodiment, the user interface rendering shown in FIG. 5B(2) is rendered by the system of FIG. 1. The user interface rendering shown in FIG. 5B(2) is meant to contrast that of FIG. 5A using specified data, for example proprietary data, customer-owned data, customer-defined data, and/or web data. Again, for the illustrative purposes of the example in FIG. 5B(2), the specified data of FIG. 5B(2) is that of an airlines management consulting organization, so that customer-owned/customer-defined data includes an intranet and database of airline companies. As shown in FIG. 5B(2), specified data may include combinations of proprietary data, customer-defined data, customer-owned data, and web data.

Similar to that in FIG. 5A, an individual document change and/or activity update over a set of documents references “What is the call sign of Southeast?”. Unlike in FIG. 5A, natural language term “Southeast” is better recognized using the proprietary data of the airlines management consulting enterprise as it establishes airline companies as a context. The change summary (554) is augmented, referred to herein as a change summary with additional contextual content associated with specified data. In one embodiment, output from (1) an LLM results/search results from proprietary data and/or (2) web search results are used to provide the augmented change summary (554). In the example of FIG. 5B(2), the augmented change summary includes web search results as a set of two cross-references and/or footnotes.

In the example of FIG. 5B(2), proprietary data such as customer-owned data is used via a search result to establish context that “Southeast” refers to an airlines. In the example of FIG. 5B(2), web data is used to provide web search results to enrich the summary and add cross-references and/or footnotes. In one embodiment, web search results are cross-referenced in the change summary, for example and without limitation as shown in response by footnotes in FIG. 5B(2). For example, a first footnote references a first web search result as a Wikipedia article (564), and a second footnote references a second web search result as a corporate website for Southeast Air (574).

Again, the augmentation reduces the ambiguity of the change summary and/or chat query or prompt given. An improvement is thus less ambiguity and/or more specific/better matches from the change summary.

Group Chat as Change Data. FIG. 5C is a user interface rendering illustrating an example of a group chat for a document. In one embodiment, the user interface rendering shown in FIG. 5C is rendered by the system of FIG. 1, and a simplification of an additional chat widget within the renderings shown in FIGS. 2A through 4C.

A plurality of users may chat with a document similar to a group text message. As shown in FIG. 5C, a chat for the Annual Budget document described in FIGS. 4A, 4B, and 4C is depicted between three users with user BB asking “What kind of clothing is this?” (582), user CC answering “Most of our wardrobe is based on children's clothing, which we have not yet broken out separately. Primarily we are using the brand Workshop, which is a little more robust, and 93% of all clothing is children's clothing from Workshop.” (584), user DD responding “Should we break that info out?” (586), and user CC replying “Yes, I'll go ahead and just rename Clothing to ‘Children's Clothing’. I'll also update the wage and other expenses given the latest forecasts that EE and their department provided on everything from raw materials to insurance rate increases.”

When an entry such as (582) is entered into the group chat, that may be considered document activity which causes the document to appear at the top of a timeline inbox such as (204) in FIG. 2A for one or more users, for example the users BB, CC, and/or DD. In one embodiment, the entry is considered a document change for one or more users, for example users BB, CC, and/or DD.

Generating Web Results using Proprietary Data. Generating web search results using proprietary data is disclosed. In one embodiment, customer-owned data is used to generate web results, with or without an intermediate step of generating an LLM result. For example, a user highlighting a sentence describing spelunking in a proprietary document generates web results on spelunking, wild caves, and speleology. In one embodiment, an intermediate step of generating an LLM result is used. In the example shown above, the highlighted sentence describing spelunking is summarized by an LLM prior to generating web search results on the spelunking summary. For example, an entire document describing spelunking trips for sale is a word processor document “July Cave Trips” drafted by a marketing team for the spelunking guide. While in their workspace, they assert a widget, for example a “Augment Context” button, which then generates web results on spelunking, wild caves, and speleology, based at least in part on the content in the “July Cave Trips” document. In one embodiment, an intermediate step of generating an LLM result is used. In this second example shown above, the entire “July Cave Trips” document describing spelunking trips for sale is summarized by an LLM to a few sentences including “These are three offered trips that the Batcave Tours company host in July here at the Gifford Pinchot National Forest, here in Washington: 1) Ape Caves—The Upper Cave has an eight-foot lava fall to explore; 2) Ape Caves—The Meatball has an incredible archway with the ‘ball’ of lava; and 3) Ape Caves—The Lower Cave is for beginners with less slope on its floors,” prior to generating web search results based on the document summary.

Augmented Chat. Using a query to generate LLM results to generate search results is disclosed. FIG. 5D is a user interface rendering illustrating an example of an augmented chat. In one embodiment, the user interface rendering shown in FIG. 5D is rendered by the system of FIG. 1, and a simplification of an additional chat widget within the renderings shown in FIGS. 2A through 4C. The augmented chat of FIG. 5D may be associated with no documents, one documents, or a plurality of documents, and may include as participant a single human user or a plurality of human users.

As shown in FIG. 5D, a user queries “What is the call sign of Southeast?” (592), the query of which is fed to an LLM. The LLM response (594) is “You ask what is the call sign for Southeast Air, which is ‘QN’.” Subsequent to the LLM result being produced, it may be used to produce search results to produce links that are appended to the LLM result in the UI of FIG. 5D, for example, an augmented paragraph (595): “This is used in radio communication and is unique to the airline¹. Additionally, the IATA code for Southeast Air is also ‘QN’¹. The ICAO code is ‘VLU’¹. Southeast Air was founded in 2006 and is headquartered in Athens, Georgia².” with links as footnotes/cross-references (596), (598): “(1) List of Airline Codes—Wikipedia [en.wikipedia.org]; (2) Southeast Air [southeast.com].”

Rather than a user query (592), a document change and/or document activity may also be used as query to a single user and/or multi-user chat, similar to that depicted in FIG. 5B(1) and FIG. 5C.

In one embodiment, the query based on document change/activity is automated. For example, a query is a change associated with a plurality of documents in a set of one or more documents, for example the “active files” (214) in the timeline of FIG. 2A. The system bases the LLM response (594), (595) on web data, and augments with web-based summary/web links (596), (598) to the timeline shown in FIG. 2A, at the “Most active” collection (206), not shown in FIG. 2A. For example, it may include an augmented summary and/or LinkedIn profile link for the “Resume-CC Test Account” and a link to the Pottery Place web site, appended to what is shown in FIG. 2A (206).

Another example, a query is a change associated with a plurality of documents in a set of one or more documents, for example the “active files” (214) in the timeline of FIG. 2A. The system bases the LLM response (594), (595) on a set of proprietary data, and augments with internal-based summary/internal links (596), (598) to the timeline shown in FIG. 2A, at the “Most active” collection (206), not shown in FIG. 2A. For example, it may include an augmented summary and/or an HR internal link for the “Resume-CC Test Account” and a link to the previous year's annual budgets from an internal search on the proprietary data, appended to what is shown in FIG. 2A (206).

Another example, a query is a change associated with a plurality of documents in a set of one or more documents, for example the “active files” (214) in the timeline of FIG. 2A. The system bases the LLM response (594), (595) on web data, and augments with internal-based summary/internal links (596), (598) to the timeline shown in FIG. 2A, at the “Most active” collection (206), not shown in FIG. 2A. For example, it may include an augmented summary and/or an HR internal link for the past associates of the CC Test Account from an internal search on the proprietary data based on an LLM response based on web data, appended to what is shown in FIG. 2A (206).

Another example, a query is a change associated with a plurality of documents in a set of one or more documents, for example the “active files” (214) in the timeline of FIG. 2A. The system bases the LLM response (594), (595) on a set of proprietary data, and augments with web-based summary/web links (596), (598) to the timeline shown in FIG. 2A, at the “Most active” collection (206), not shown in FIG. 2A. For example, it may include an augmented summary and/or a LinkedIn profile for direct reports of CC Test Account from a web search based on an LLM response based on a set of proprietary data, appended to what is shown in FIG. 2A (206).

Another example, a query is a change associated with one document in a set of one or more documents, for example the “Latest update” (264) in the timeline of FIG. 2B: the query includes “Test Account created a new photo album documenting a West Coast road trip featuring four people and three dogs, with stops at Long Beach and Malibu.” The system bases the LLM response (594), (595) on web data, and augments with web-based summary/web links (596), (598) to the timeline shown in FIG. 2B, at the “Latest update” (264), not shown in FIG. 2B. For example, it may include an augmented summary and/or link to the Long Beach Wikipedia TM article, Malibu Wikipedia TM article, and a summary of road trip ideas between Long Beach and Malibu appended to what is shown in FIG. 2B (264).

Another example, a query is a change associated with one document in a set of one or more documents, for example the “Latest update” (264) in the timeline of FIG. 2B: the query includes “Test Account created a new photo album documenting a West Coast road trip featuring four people and three dogs, with stops at Long Beach and Malibu.” The system bases the LLM response (594), (595) on a set of proprietary data, and augments with internal-based summary/internal links (596), (598) to the timeline shown in FIG. 2B, at the “Latest update” (264), not shown in FIG. 2B. For example, it may include an augmented summary and/or link to internal marketing data for the target demographics for West Coast tourism appended to what is shown in FIG. 2B (264).

Another example, a query is a change associated with one document in a set of one or more documents, for example the “Latest update” (264) in the timeline of FIG. 2B: the query includes “Test Account created a new photo album documenting a West Coast road trip featuring four people and three dogs, with stops at Long Beach and Malibu.” The system bases the LLM response (594), (595) on web data, and augments with internal-based summary/internal links (596), (598) to the timeline shown in FIG. 2B, at the “Latest update” (264), not shown in FIG. 2B. For example, it may include an augmented summary and/or link to the Juan Bautista de Anza Park internal visitor numbers uncovered in a web search between Long Beach and Malibu appended to what is shown in FIG. 2B (264).

Another example, a query is a change associated with one document in a set of one or more documents, for example the “Latest update” (264) in the timeline of FIG. 2B: the query includes “Test Account created a new photo album documenting a West Coast road trip featuring four people and three dogs, with stops at Long Beach and Malibu.” The system bases the LLM response (594), (595) on a set of proprietary data, and augments with web-based summary/web links (596), (598) to the timeline shown in FIG. 2B, at the “Latest update” (264), not shown in FIG. 2B. For example, it may include an augmented summary and/or link to the company's beach house door code at Long Beach including a web link for the user's manual for the alarm, appended to what is shown in FIG. 2B (264).

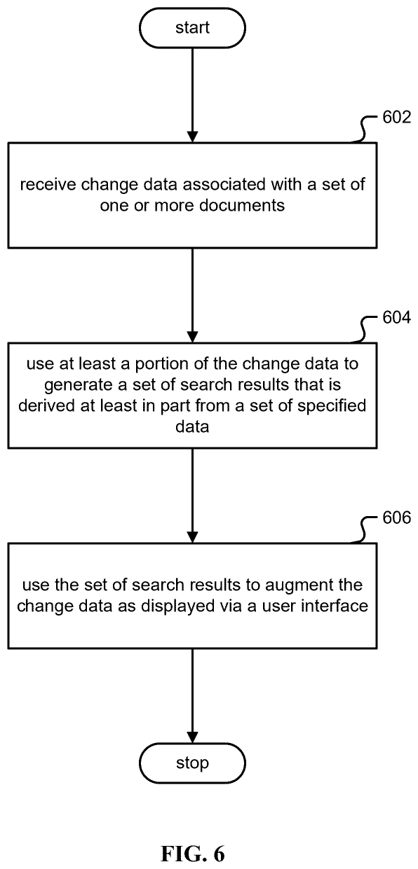

FIG. 6 is a flow diagram illustrating an embodiment of a process for augmenting a timeline of document changes. In one embodiment, the process of FIG. 6 is carried out by the system of FIG. 1.

In step (602), a change data associated with a set of one or more documents is received. In one embodiment, a document in the set of one or more documents is a file or any discrete chunk of information.

In one embodiment, the change data is an activity update associated with a plurality of documents in the set of one or more documents. In one embodiment, the change data is an individual change summary associated with one document in the set of one or more documents.

In step (604), at least a portion of the change data is used to generate a set of search results that is derived at least in part from a set of specified data.

In one embodiment, the change data is associated with a plurality of documents in the set of one or more documents; the set of specified data comprises data from a web; and the set of search results comprises web search results. In one embodiment, the change data is associated with a plurality of documents in the set of one or more documents; the set of specified data comprises proprietary data; and the set of search results comprises proprietary data search results. In one embodiment, the set of specified data is a combination of data from a web and proprietary data and the set of search results comprises proprietary data search results and web search results.

In one embodiment, the change data is associated with one document in the set of one more documents; the set of specified data comprises data from a web; and the set of search results comprises web search results. In one embodiment, the change data is associated with one document in the set of one more documents; the set of specified data comprises proprietary data; and the set of search results comprises proprietary data search results. In one embodiment, the set of specified data is a combination of data from a web and proprietary data and the set of search results comprises proprietary data search results and web search results.

In step (606), the set of search results is used to augment the change data as displayed via a user interface. In an optional step not shown in FIG. 6, a user input data is received as a selection of a plurality of documents to initiate a chat with; the change data is associated with a plurality of documents in the set of one or more documents; and the chat is augmented with the set of search results. In one embodiment, the chat is further augmented with a context of a chat history.

In one embodiment, in an optional step not shown in FIG. 6 a group chat is attached to a document such that a message posted to the group chat is handled like a change data to the document.

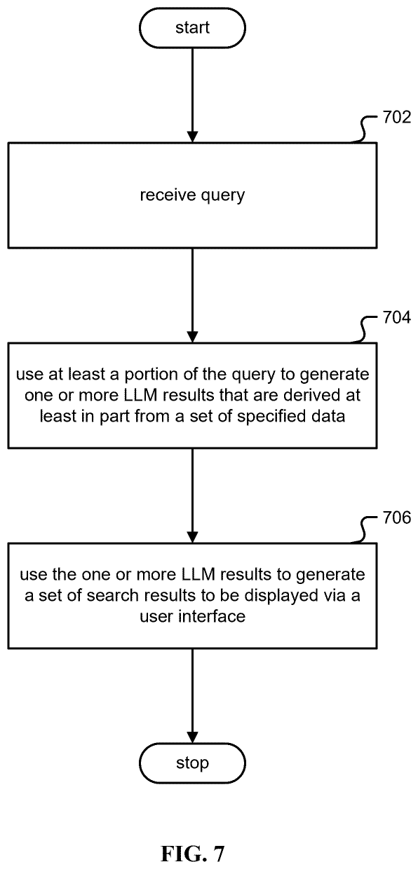

FIG. 7 is a flow diagram illustrating an embodiment of a process for generating search results from a query. In one embodiment, the process of FIG. 7 is carried out by the system of FIG. 1.

In step (702), a query is received. In one embodiment, the query is a user query, for example as shown in FIG. 5D. In step (704), at least a portion of the query is used to generate one or more LLM results that are derived at least in part from a set of specified data. In step (706), the one or more LLM results are used to generate a set of search results to be displayed via a user interface.

In one embodiment, the query is a change associated with a plurality of documents in a set of one or more documents; the set of specified data comprises data from a web; and the set of search results comprises web results.

In one embodiment, the query is a change associated with a plurality of documents in a set of one or more documents; the set of specified data comprises a set of proprietary data; and the set of search results comprises proprietary data search results.

In one embodiment, the query is a change associated with a plurality of documents in a set of one or more documents; the set of specified data comprises data from a web; and the set of search results comprises proprietary data search results.

In one embodiment, the query is a change associated with a plurality of documents in a set of one or more documents; the set of specified data comprises a set of proprietary data; and the set of search results comprises web results.

In one embodiment, the query is a change associated with one document in a set of one more documents; the set of specified data comprises data from a web; and the set of search results comprises web results.

In one embodiment, the query is a change associated with one document in a set of one more documents; the set of specified data comprises a set of proprietary data; and the set of search results comprises proprietary data search results.

In one embodiment, the query is a change associated with one document in a set of one more documents; the set of specified data comprises data from a web; and the set of search results comprises proprietary data search results.

In one embodiment, the query is a change associated with one document in a set of one more documents; the set of specified data comprises a set of proprietary data; and the set of search results comprises web results.

In one embodiment, the query comprises proprietary data and the set of search results comprises web search results.

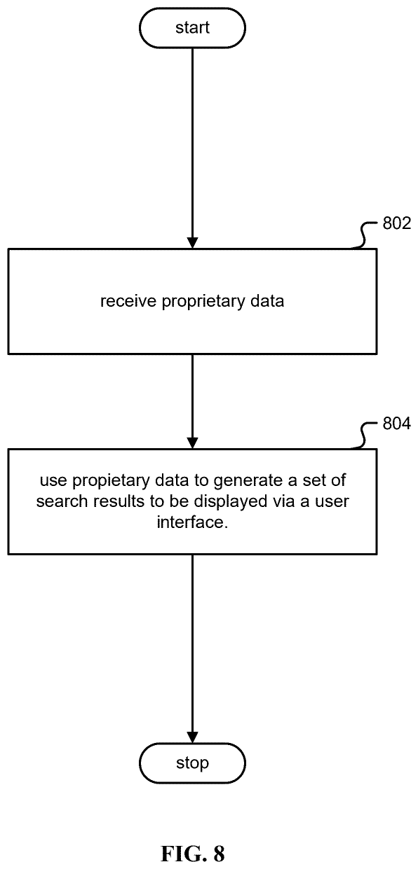

FIG. 8 is a flow diagram illustrating an embodiment of a process for generating search results from proprietary data. In one embodiment, the process of FIG. 7 is carried out by the system of FIG. 1. In step (802), a proprietary data is received. In step (804), the proprietary data is used to generate a set of search results to be displayed via a user interface.

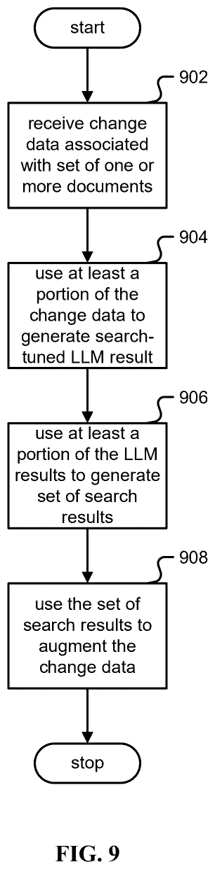

FIG. 9 is a flow diagram illustrating an embodiment of a process for generating search results using a search-tuned LLM. In one embodiment, the process of FIG. 9 is carried out by the system of FIG. 1.

In step (902), a change data associated with a set of one or more documents is received. In step (904), at least a portion of the change data is used to generate one or more search-tuned LLM results. In step (906), at least a portion of the search-tuned LLM results are used to generate a set of search results that is derived at least in part from a set of specified data. In step (908), the set of search results is used to augment the change data as displayed via a user interface.

In one embodiment, the change data is associated with a plurality of documents in the set of one or more documents; the set of specified data comprises data from a web; and the set of search results comprises web search results. In one embodiment, the change data is associated with a plurality of documents in the set of one or more documents; the set of specified data comprises proprietary data; and the set of search results comprises proprietary data search results.

In one embodiment, the change data is associated with one document in the set of one more documents; the set of specified data comprises data from a web; and the set of search results comprises web search results. In one embodiment, the change data is associated with one document in the set of one more documents; the set of specified data comprises proprietary data; and the set of search results comprises proprietary data search results.

Although the foregoing embodiments have been described in some detail for purposes of clarity of understanding, the invention is not limited to the details provided. There are many alternative ways of implementing the invention. The disclosed embodiments are illustrative and not restrictive.

1. A system, comprising:
a communication interface; and
a processor coupled to the communication interface and configured to:
receive via the communication interface a change data associated with a set of one or more documents;
use at least a portion of the change data to generate a set of search results that is derived at least in part from a set of specified data; and
use the set of search results to augment the change data as displayed via a user interface with a cross-reference to a web data and/or proprietary data,
wherein the augmented change data is ordered and/or hidden based at least in part on a relevance metric assessed at least in part by an LLM (large language model).

2. The system of claim 1, wherein a document in the set of one or more documents is a file or any discrete chunk of information.

3. The system of claim 1, wherein: the change data is associated with a plurality of documents in the set of one or more documents; the set of specified data comprises data from a web; and the set of search results comprises web search results.

4. The system of claim 1, wherein: the change data is associated with a plurality of documents in the set of one or more documents; the set of specified data comprises proprietary data; and the set of search results comprises proprietary data search results.

5. The system of claim 1, wherein: the change data is associated with one document in the set of one more documents; the set of specified data comprises data from a web; and the set of search results comprises web search results.

6. The system of claim 1, wherein: the change data is associated with one document in the set of one more documents; the set of specified data comprises proprietary data; and the set of search results comprises proprietary data search results.

7. The system of claim 1, wherein: the processor is further configured to receive a user input data via the communication interface; the user input data is a selection of a plurality of documents to initiate a chat with; the change data is associated with a plurality of documents in the set of one or more documents; and the chat is augmented with the set of search results.

8. The system of claim 7, wherein the chat is further augmented with a context of a chat history.

9. The system of claim 1, wherein the change data is an activity update associated with a plurality of documents in the set of one or more documents.

10. The system of claim 1, wherein: the change data is an individual change summary associated with one document in the set of one or more documents.

11. The system of claim 1, wherein the processor is further configured to attach a group chat to a document such that a message posted to the group chat is handled like a change data to the document.

12. A system, comprising:
a communication interface; and
a processor coupled to the communication interface and configured to:
receive via the communication interface a query;
use at least a portion of the query to generate one or more LLM results that are derived at least in part from a set of specified data; and
use the one or more LLM results to generate a set of search results to be displayed via a user interface with a cross-reference to a web data and/or proprietary data;
wherein the generated set of search results to be displayed is ordered and/or hidden based at least in part on a relevance metric assessed at least in part by an LLM.

13. The system of claim 12, wherein the query is a user query.

14. The system of claim 12, wherein: the query is a change associated with a plurality of documents in a set of one or more documents; the set of specified data comprises data from a web; and the set of search results comprises web results.

15. The system of claim 12, wherein: the query is a change associated with a plurality of documents in a set of one or more documents; the set of specified data comprises a set of proprietary data; and the set of search results comprises proprietary data search results.

16. The system of claim 12, wherein: the query is a change associated with a plurality of documents in a set of one or more documents; the set of specified data comprises data from a web; and the set of search results comprises proprietary data search results.

17. The system of claim 12, wherein: the query is a change associated with a plurality of documents in a set of one or more documents; the set of specified data comprises a set of proprietary data; and the set of search results comprises web results.

18. The system of claim 12, wherein: the query is a change associated with one document in a set of one more documents; the set of specified data comprises data from a web; and the set of search results comprises web results.

19. The system of claim 12, wherein: the query is a change associated with one document in a set of one more documents; the set of specified data comprises a set of proprietary data; and the set of search results comprises proprietary data search results.

20. The system of claim 12, wherein: the query is a change associated with one document in a set of one more documents; the set of specified data comprises data from a web; and the set of search results comprises proprietary data search results.

21. The system of claim 12, wherein: the query is a change associated with one document in a set of one more documents; the set of specified data comprises a set of proprietary data; and the set of search results comprises web search results.

22. The system of claim 12, wherein: the query comprises proprietary data and the set of search results comprises web search results.

23. A system, comprising:
a communication interface; and
a processor coupled to the communication interface and configured to:
receive via the communication interface a proprietary data; and
use the proprietary data to generate a set of search results to be displayed via a user interface with a cross-reference to the proprietary data;
wherein the generated set of search results to be displayed is ordered and/or hidden based at least in part on a relevance metric assessed at least in part by an LLM.

24. A system, comprising:
a communication interface; and
a processor coupled to the communication interface and configured to:
receive via the communication interface a change data associated with a set of one or more documents;
use at least a portion of the change data to generate one or more search-tuned LLM results;
use at least a portion of the search-tuned LLM results to generate a set of search results that is derived at least in part from a set of specified data; and
use the set of search results to augment the change data as displayed via a user interface with a cross-reference to a web data and/or proprietary data,
wherein the augmented change data is ordered and/or hidden based at least in part on a relevance metric assessed at least in part by another LLM.

25. The system of claim 24, wherein: the change data is associated with a plurality of documents in the set of one or more documents; the set of specified data comprises data from a web; and the set of search results comprises web search results.

26. The system of claim 24, wherein: the change data is associated with a plurality of documents in the set of one or more documents; the set of specified data comprises proprietary data; and the set of search results comprises proprietary data search results.

27. The system of claim 24, wherein: the change data is associated with one document in the set of one more documents; the set of specified data comprises data from a web;
and the set of search results comprises web search results.

28. The system of claim 24, wherein: the change data is associated with one document in the set of one more documents; the set of specified data comprises proprietary data;
and the set of search results comprises proprietary data search results.

29. A method, comprising:
receiving a change data associated with a set of one or more documents;
using at least a portion of the change data to generate a set of search results that is derived at least in part from a set of specified data; and
using the set of search results to augment the change data as displayed via a user interface with a cross-reference to a web data and/or proprietary data;
wherein the augmented change data to be displayed is ordered and/or hidden based at least in part on a relevance metric assessed at least in part by an LLM.

30. A computer program product embodied in a non-transitory computer readable medium and comprising computer instructions for:
receiving a change data associated with a set of one or more documents;
using at least a portion of the change data to generate a set of search results that is derived at least in part from a set of specified data; and
using the set of search results to augment the change data as displayed via a user interface with a cross-reference to a web data and/or proprietary data;
wherein the augmented change data to be displayed is ordered and/or hidden based at least in part on a relevance metric assessed at least in part by an LLM.

31. A method, comprising:
receiving a query;
using at least a portion of the query to generate one or more LLM results that are derived at least in part from a set of specified data; and
using the one or more LLM results to generate a set of search results to be displayed via a user interface with a cross-reference to a web data and/or proprietary data;
wherein the generated set of search results to be displayed is ordered and/or hidden based at least in part on a relevance metric assessed at least in part by an LLM.

32. A computer program product embodied in a non-transitory computer readable medium and comprising computer instructions for:
receiving a query;
using at least a portion of the query to generate one or more LLM results that are derived at least in part from a set of specified data; and
using the one or more LLM results to generate a set of search results to be displayed via a user interface with a cross-reference to a web data and/or proprietary data;
wherein the generated set of search results to be displayed is ordered and/or hidden based at least in part on a relevance metric assessed at least in part by an LLM.

33. A method, comprising:
receiving a change data associated with a set of one or more documents;
using at least a portion of the change data to generate one or more search-tuned LLM results;
using at least a portion of the search-tuned LLM results to generate a set of search results that is derived at least in part from a set of specified data; and
using the set of search results to augment the change data as displayed via a user interface with a cross-reference to a web data and/or proprietary data;
wherein the generated set of search results to be displayed is ordered and/or hidden based at least in part on a relevance metric assessed at least in part by an LLM.

34. A computer program product embodied in a non-transitory computer readable medium and comprising computer instructions for:
receiving a change data associated with a set of one or more documents;
using at least a portion of the change data to generate one or more search-tuned LLM results;
using at least a portion of the search-tuned LLM results to generate a set of search results that is derived at least in part from a set of specified data; and
using the set of search results to augment the change data as displayed via a user interface with a cross-reference to a web data and/or proprietary data;
wherein the augmented change data to be displayed is ordered and/or hidden based at least in part on a relevance metric assessed at least in part by an LLM.
